(19) United States
(12) Patent Application Publication
(10) Pub. No.: US 2010/0151166 A1
(43) Pub. Date: Jun. 17, 2010

(54) MICRO-PERFORATED POLY(LACTIC) ACID PACKAGING SYSTEMS AND METHOD OF PREPARATION THEREOF

(76) Inventors: Eva Almenar, Okemos, MI (US); Rafael Auras, Lansing, MI (US); Hayati Samsudin, East Lansing, MI (US); Bruce Harte, Bath, MI (US); Maria Rubino, East Lansing, MI (US); Janice Harte, Bath, MI (US)

Correspondence Address: HOWARD & HOWARD ATTORNEYS PLLC, 450 West Fourth Street, Royal Oak, MI, 48067, US

(21) Appl. No.: 12/637,625

(22) Filed: Dec. 14, 2009

Related U.S. Application Data
(60) Provisional application No. 61/122,192, filed on Dec. 12, 2008.
(60) Provisional application No. 61/145,422, filed on Jan. 16, 2009.

(51) Int. Cl. B32B 1/02; B32B 38/04

(52) U.S. Cl. 428/35.2; 428/36.5; 156/252

(57) ABSTRACT

Systems and methods for forming bio-based microperforated packages substantially composed of poly(lactic acid) which are particularly useful for storing respiring products in that the respiration rate (i.e., CO₂ and O₂ fluxes) can be controlled and the water vapor transmission rates reduced, thus inhibiting weight loss and prolonging the quality and shelf life of such respiring products, by, among other things, varying the amount of microperforations in the package.

### BACKGROUND OF THE INVENTION

The present invention relates generally to packaging systems, and more particular, to packaging systems constructed from a micro-perforated biobased polymeric material, such as poly(lactic) acid (“PLA”), and systems and methods for micro-perforating such biobased polymeric materials.

Packaging food for respiring products, such as fruits, vegetables or flowers, have historically been made from petroleum-based polymeric materials. These materials may be in the form of a continuous film which may be microperforated.

Microperforated films mitigate the high/low concentrations carbon dioxide (CO₂) and oxygen (O₂), respectively, which may occur in a continuous film packaging system for respiring fresh produce. This may avoid anaerobic respiration, which can lead to a variety of undesirable characteristics, such as off-flavors or senescence. Microperforated films also allow or foster the rapid development of adequate CO₂ and O₂ levels to extend produce shelf life. However, the relative permeability of water vapor is increased with the presence of microperforation in a polymeric material.

The permeability of the plastic to the water vapor determines water loss from the produce. Fresh produce packaged with microperforated petroleum-based packaging systems have a higher weight loss during storage than the same fresh product packaged using a continuous film. The weight lost is dependent on the number and area of the microperforations, that is, the higher the number of microperforations and the greater the area of the microperforations, the higher the weight loss of the fresh produce.

Another issue relates to microperforated petroleum based packaging systems being non-compostable, and therefore, end up in landfills after use.

PLA presents weak barriers to water vapor, CO₂, and O₂ and thus, the number of applications for PLA in the area of fresh produce packaging is generally thought to be limited.

### SUMMARY OF THE INVENTION

The invention is generally directed to a packaging system and method of making the same which includes features that maintain the integrity and prolong the lifespan of perishable products contained therein.

In some embodiments, the invention is directed to systems and methods for providing a packaging system having a body constructed of a biobased material with a storage space defined therein, which includes microperforations in the body that affect one or more atmospheric conditions within the storage space to enhance performance properties relating to the packaging system. The packaging system body may include various components, such as a top portion or cover or lid, a bottom portion or tray having sidewalls to define a cavity or storage space therein. The top and bottom are either engaged or sealed to substantially enclose the storage space therein, which may contain perishable products. The storage space may also be sealed by placing a layer of film over a bottom portion containing the products therein, and sealing the layer of film onto the upper sidewall edges or sidewall surfaces.

In one aspect of the present invention, a method for micro-perforating poly(lactic acid) (PLA), a biobased polymeric material, in order to modify its permeability and therefore increase its potential application to fresh produce, is provided. In another aspect of the present invention, a packaging system using microperforated PLA film is provided. The microperforated film may be used to form pouches or used as a lidding film for semi-rigid containers. Use of microperforated PLA films as the lidding material for semi-rigid containers reduces the water vapor transmission rate of the packaging system (which is unexpectedly contrary to what happens when using petroleum based microperforated films) and thereby, reduce the respiring product weight loss and thus shriveling and wilting.

In still another aspect of the present invention, a method of forming microperforated PLA films to form pouches which will reduce the water vapor transmission rate of the packaging system and thereby, reduce the respiring product weight loss and thus shriveling and wilting, is provided.

In an additional aspect of the present invention, microperforated PLA films to produce packaging systems, are provided, which extend the quality and shelf life of respiring products such as fresh fruit, fresh vegetables, fresh herbs and fresh flowers during storage and distribution.

In one embodiment, the invention is directed to a packaging system which includes a sidewall, bottom and lid formed substantially of a biobased polymeric material and configured to enclose a storage space defined therein, wherein at least a portion of the sidewall, bottom or lid is microperforated. The polymeric material may be poly(lactic acid).

In some embodiments, the aforementioned packaging system is in the form of a sealable pouch. In other embodiments, the aforementioned packaging system includes a separable tray and a lid composed of the polymeric material.

In some embodiments, the number, size or shape of the microperforations is selected based on the product to be enclosed in the storage space. The microperforations may also be the same size or shape or vary.

In another embodiment, the invention is directed to a method of forming a packaging system, which includes the steps of transferring a film of biobased polymeric material between a first roller and a second roller; microperforating the film material; and sealing the film material over a tray, wherein the tray includes a bottom, and sidewall defining a storage space therein. The microperforations may be uniformly distributed along the film material and elliptical in shape.

In another embodiment, the invention is directed to a package which includes a bottom portion including a sidewall and a bottom surface, defining a storage space therein, and a top portion configured for being engaged with the bottom portion to substantially enclose the storage space. The top portion may be at least partially composed of a microperforated PLA material.

In some embodiments, the top portion of the aforementioned package may be a film material configured for being sealed over the bottom portion. The top portion may also be substantially composed of microperforated PLA. The microperforations in the PLA material may be uniformly distributed, and may be in an amount between 1 and 20.

In some embodiments of the aforementioned package, the bottom portion is composed substantially of PLA or may at least be partially composed of microperforated PLA.

### BRIEF DESCRIPTION OF THE DRAWINGS

Other advantages of the invention will be readily appreciated by reference to the following detailed description when considered in connection with the accompanying drawings, wherein:

FIGS. 1a-c is a series of schematic diagrams illustrating a exemplary process for micro-perforating a biobased polymeric material, such as poly(lactic acid) or PLA, and the formation of an exemplary packaging system, according to some embodiments of the invention;

FIG. 2 is a side view of a tray portion used with a micro-perforated PLA packaging system constructed according to some embodiments of the invention;

FIG. 3 is a magnification of an exemplary single microperforation formed in a PLA packaging system constructed according to some embodiments of the invention;

FIGS. 4a and 4b are graphs illustrating the effect of the number of perforation (0, 6, and 15) on the water vapor rate transmission rate through PLA and PET based packaging systems, respectively, according to some embodiments of the invention;

FIGS. 5a and 5b are graphs illustrating the effect of the number of perforation (0, 3, and 7) on the water vapor rate transmission rate through PLA and PET based packaging systems, respectively, according to some embodiments of the invention;

FIG. 6 is a graph illustrating the effect of the number of perforations (0 and 6) on the water transmission rate through PLA and PET based pouches;

FIG. 7 is a graph illustrating the effect of the number of perforations (0, 3, and 15) in a PLA material on the weight loss of cultivated strawberries;

FIGS. 8a and 8b are graphs illustrating the effect of the number of perforations (0 and 15) in a lidding material composed of a PLA material on two different batches of strawberries;

FIGS. 9a-d are graphs illustrating the effect of the number of perforations (0, 3, 6, and 15) in a lidding material composed of a PLA material on headspace gas evolution during 4 days of storage at a temperature of 25° C.;

FIGS. 10a and 10b includes 4 graphs illustrating the effect of the number of perforations (0 and 3) in a lidding material composed of a PLA material on headspace gas evolution during 11 days of storage at a temperature of 3° C.; and

FIG. 11 includes a table which illustrates the percentage of decayed cultivated strawberries in PLA packages with continuous or Microperforated lidding materials and PET clamshell containers at 3° C. and 23° C.

### DETAILED DESCRIPTION OF INVENTION

In accordance with some embodiments of the invention, it has been found that in microperforated PLA-based packaging systems in which microperforated PLA film is used to form pouches, or is the lidding material used for PLA semi-rigid containers, the presence of microperforations reduces the water vapor transmission rate, and thus, reduces the weight loss of the fresh product. Other mass transfer processes like those for CO₂ and O₂ show the same behavior as expected for microperforated petroleum-based packaging systems. Higher or lower levels of O₂ and CO₂, respectively, than those achieved when using continuous films are developed in the headspace of microperforated packaging systems.

These packages, when used for products with medium/high respiration rates, will have reduced detrimental physico-chemical changes such as acidification, off-flavor development, and others during storage. Therefore, microperforated PLA-based packaging systems which use microperforated PLA film as a lidding material for semi-rigid PLA trays or microperforated PLA for pouches will be more effective than microperforated petroleum-based packaging systems in prolonging fresh product shelf life. Weight loss will be reduced in addition to controlling the high/low concentrations of CO₂ and O₂ (which could be far from the desired gaseous levels) that might be reached inside the package when continuous films are used to package the respiring produce.

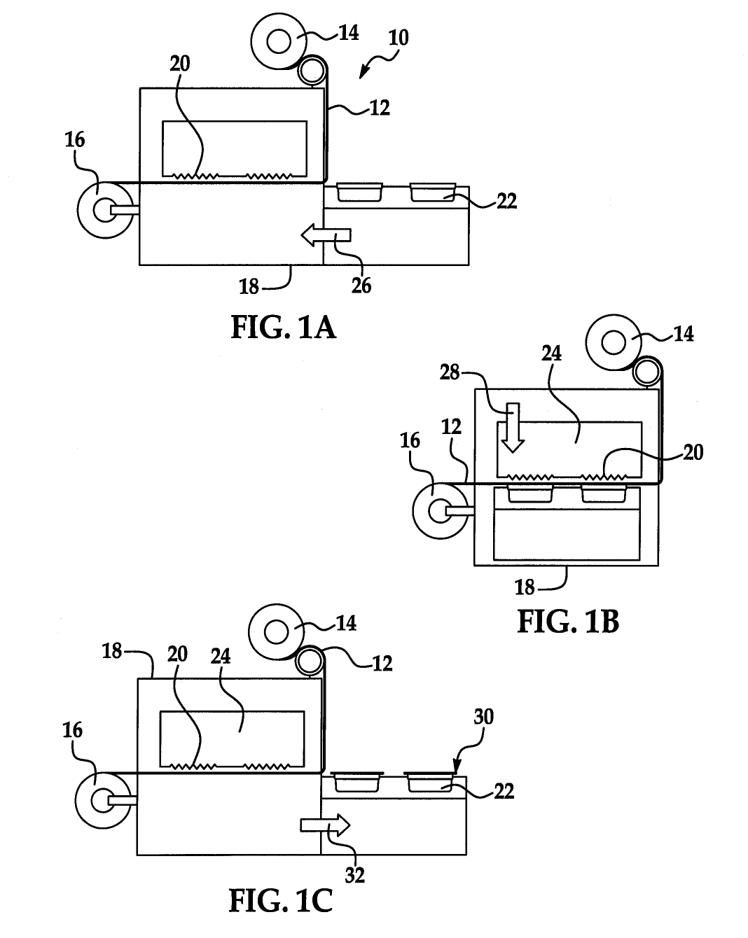

Polymeric film based on PLA (coated with a thin layer of ethylene vinyl acetate) of about 57 μm thickness was mechanically microperforated (pore size less than about 2,000 μm) using cold micro needles. For this purpose, a carrier with needles (i.e., a pinning tool) is fixed onto a metal cylinder (as shown schematically in FIG. 1) which is able to rotate due to the pressure exerted between the needles and the polymeric material. Different numbers of microperforations were achieved by using different pinning tools (i.e., pinning tools which have different amounts of needles). The larger the distance between needles, the lower the number of microperforations for a specific area in the polymeric material. The pinning tools were adjusted to produce microperforations that were consistent in position and density over a large number of replications. Different numbers of microperforations than those used in this invention could be produced in the PLA film to prolong shelf life of respiring product. The number of microperforations will be dependent on the intrinsic and extrinsic factors of the produce/packaging systems, such as respiration rate, relative humidity, temperature, size of package, storage time, etc.

PLA could also be microperforated using a number of different ways in addition to mechanical needle microperforation. Microperforations could be obtained using laser, electrostatic discharge, etc.

### Method of Forming Microperforated Packaging Systems

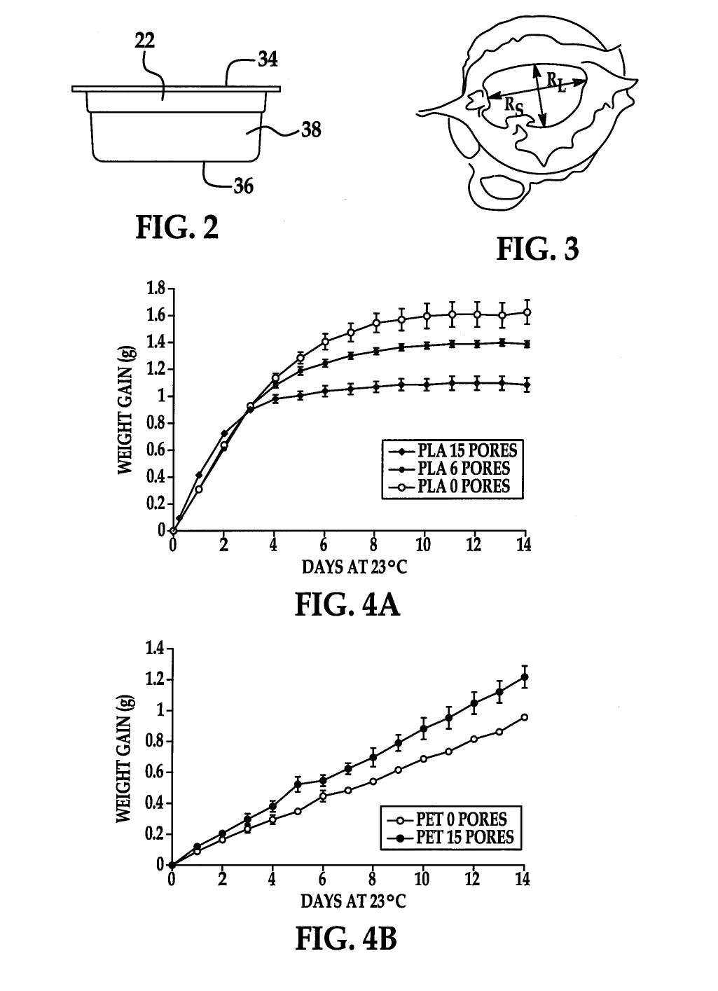

An exemplary method 10 of developing microperforated packaging systems is schematically illustrated in FIGS. 1a-1c. A PLA film 12 was transferred from a first roll 14 to a second roll 16 through a suitable sealing machine 18 such as a MULTIVAC T200 (Multivac Inc., Mo., USA) machine as shown in FIG. 1a. Moving film 12 passes under a pinning tool 20 having needles, thus causing the microperforation of the bio-based material. In the next step, trays 22 (examples of which are also shown in FIG. 2), which are substantially formed of PLA, are moved into sealing area 24 as illustrated by arrow 26. Film 12 is thermosealed to each respective tray 22 as shown in FIG. 1b (and illustrated by arrow 28) to form rigid packages 30. The film is cut around trays 22 and packages 30 are ejected in FIG. 1c, as illustrated by arrow 32, now including a cover or lid 34.

The presence or absence of pores (microperforations), or continuous lidding material, respectively, is at least partially dependent on the position of the pinning tool, that is, the relative distance of the tool from film 12. The pinning tool 20 may be moved farther or closer to the film 12, manually or otherwise, depending on the characteristics of microperforations desired for the particular application. To form microperforated pouches in some embodiments the lidding film 12 is pulled out of the machine and then sealed to form sides, top and bottom using an impulse bar sealer or other similar device (not shown). As shown in FIG. 2, tray 22 includes a bottom 36 and side wall 38 sealed by lid 34 to define a storage space therein.

### Parts of the Microperforated Packaging System

Semi-Rigid PLA Trays with Peelable Continuous or Microperforated Flexible Lids

Through method 10 a microperforated packaging system was formed using a semi-rigid PLA tray with a thickness of about 240 μm and a microperforated PLA lid with a thickness of about 57 μm. The microperforated PLA lid was formed from a flexible thermoplastic film material with a selected number (such as 3, 6, 15 or none) of microperforations, each having approximate dimensions of about 200 μm (R1) by about 100 μm (R2) and forming a substantially elliptical shape as illustrated in FIG. 3. The void area of the film was calculated as follows:

$$Void ( \% ) = \frac{π \times {R}_{S} \times {R}_{L} x N}{{L}^{2}} \times 100$$

where R_{S} and R_{L} are the short and long ratios of the ellipse, respectively, N is the number of microperforations and L is the length of a side assuming a square package.

In some embodiments, the microperforations may vary in size and shape, and may also be uniformly distributed or inconsistent in positioning along the package, including the lid, sidewall and bottom. In other embodiments, such as the one described herein, the microperforations were roughly the same size and shape, as well as consistent in position and density over a large number of replications using method 10.

Microperforated PLA pouches were formed using two pieces of continuous or microperforated flexible PLA having a thickness of about 57 μm. In some embodiments, the microperforated pouches had a selected number of microperforations (such as 6 and 28) of approximate dimensions 200 μm (R1)×100 μm (R2) and having a substantially elliptical shape. The void area of the film was calculated using the above formula.

### Characterization of the Microperforated Poly(Lactic Acid) Packaging System

### Mass Transfer Studies—Studies of Water Permeability of the PLA Packages

Water vapor transmission rates (WVTR) for PLA and poly(ethylene terephthalate) (PET) packages with different numbers of microperforations (0, 6 and 15, respectively) were measured using a modified ASTM D 3079-94 (Standard test method for water vapor transmission of flexible heat-sealed packages for dry products). After filling the packages with desiccant and sealing them with microperforated or continuous lidding material (using a MULTIVAC T200), the packages were stored for several days at approximately 23° C. and high relative humidity. Packages were weighed daily using a precision scale. Four packages (replications) were used for each type of packaging system. The graph in FIG. 4a illustrates the effect of the number of microperforations on the water vapor transmission rate through the developed packaging system during storage. As shown by the graph, the different PLA packaging systems exhibited different permeabilities.

With regard to the PLA packages, the larger number of microperforations (and thus the greater the void area in the lid of the package), generally resulted in the lower the amount of water absorbed by the desiccant, indicating a lower water vapor transference through the packaging system. In contrast, PET packaging systems showed an opposite behavior, that is, the greater the number of microperforations, the higher the water vapor transmission rate, as can be seen in FIG. 4b.

Since the weight loss of a respiring product is dependent on the WVTR of its package, higher WVTR is conducive to higher weight loss. Therefore, microperforated PLA packaging systems will be able to increase the marketability of the commodity when compared with poly(ethylene terephthalate) packaging systems (petroleum based package), by providing a reduction in water loss, among other things.

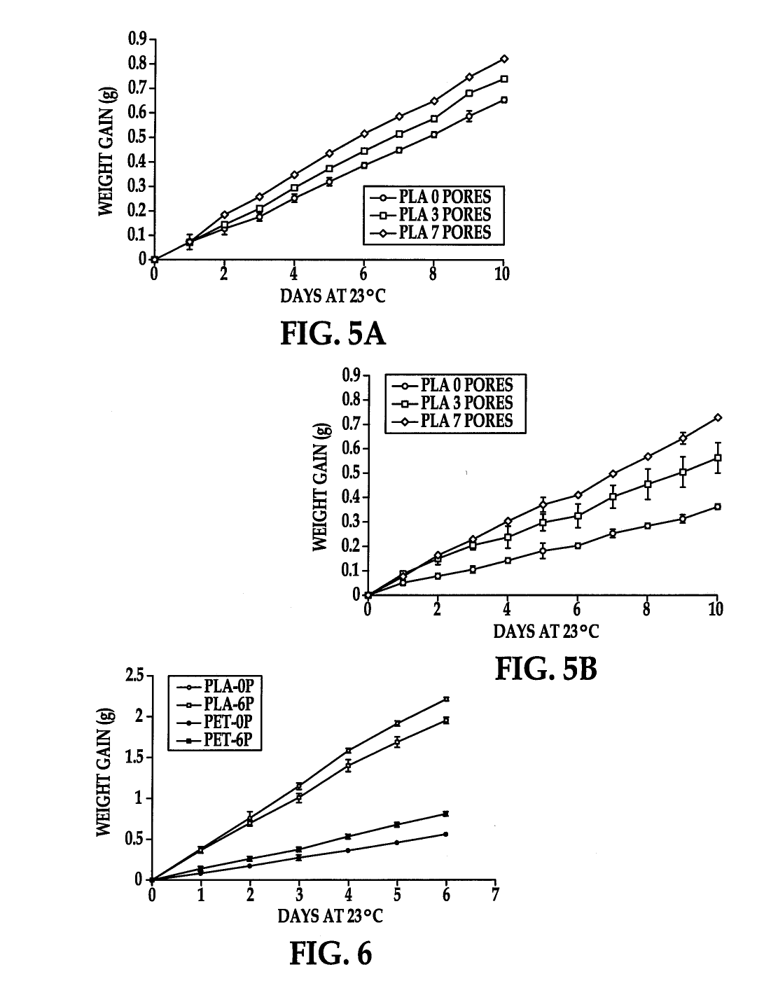

WVTR of continuous and microperforated PLA and PET films (0, 3, 5 and 7 pores) and pouches (0 and 6 pores) was also measured using the aforementioned ASTM D 3079-94 and conditions during storage at 23° C. and 100% relative humidity (RH). Microperforated films showed higher WVTR than continuous films (i.e., 0 pores), that is, the desiccant had absorbed more water. The higher the number of microperforations, the higher the transmission rate as shown in FIGS. 5a and 5b. Same behavior was observed in the PET pouches. However, PLA pouches showed the same behavior than when the microperforated PLA films were used as the lidding material for the rigid containers (i.e., lower water weight gain as the number of perforations and void area increases), as shown in FIG. 6. Thus, the results show that the water permeability of the PLA packaging system is reduced when microperforated PLA is used as lidding material for PLA trays and/or for formed pouches, but not just when a microperforated material was used per se as film.

Using in vivo Assays

### Examples

PLA trays were filled with cultivated strawberries (Fragaria×ananassa Duch.) (3 fruits) and then thermosealed with PLA film with and without microperforations. The same amount of berries was used for filling poly(ethylene terephthalate) (PET clamshell containers), a packaging system exemplifying those currently used in the market. PLA packages with 0 and 3 microperforations, respectively, and controls were randomly divided. Then half of the sealed packages were stored at 3° C. and 45% relative humidity and the others at 23° C. and 55% relative humidity for 11 and 8 days, respectively. Different temperatures were used in order to determine temperature effects on the development of the modified atmosphere inside the bio-based containers. The temperatures were chosen to generally model the typical values achieved during storage, transport and berry retailing.

The effect of the number of microperforations on the development of different atmospheres was also studied. PLA packages with larger numbers of microperforations (6 and 15) were stored at 23° C. and 55% relative humidity for 8 days in addition to those with 0 and 3 microperforations mentioned above. Four packages (replications) for each packaging system and storage temperature were used in this exemplary analysis. For all packages and temperatures, key quality parameters for strawberries, such as weight loss, fungal growth (Botrytis cinerea) and headspace evolution (CO₂ and O₂ levels) were analyzed during storage.

### Weight Loss

The weight loss of cultivated strawberries packaged in microperforated PLA packaging systems was monitored during 8 and 11 days of storage at 23° C. and 55% relative humidity and 2° C. and 45% relative humidity, respectively. Cultivated strawberry weight was recorded before (initial weight, W_{O}, and during storage, Wₜ). Both values were determined using an analytical balance. The weight loss was calculated as follows:

$$Weight Loss ( \% ) = \frac{{W}_{O} - {W}_{t}}{{W}_{O}} \times 100$$

According to the literature, fresh product is still in marketable conditions when the weight loss is below 10%. Tabil and Sokhansanj (2000) reported that a weight loss of 5-10% is experienced by fresh produces, it will contribute to significant wilting, shriveling, poor texture and taste (Tabil. L. G; Sokhansanj, S. 2000, Mechanical and temperature effects on shelf life stability of fruits and vegetables. In: Food shelf life stability: Chemical, biochemical and microbiological changes. CRC Press: Amherst, 2001). Ohta, Shiina and Sasaki (2002) reported weight loss in excess of 5% as a cause of a reduction in retail value of vegetables and fruits (Ohta, H; Shiina, T; Sasaki. K. 2002. Dictionary of freshness and shelf-life of fruit. Tokyo: Science Forum Co. Ltd). The aforementioned disclosures are herein incorporated by reference.

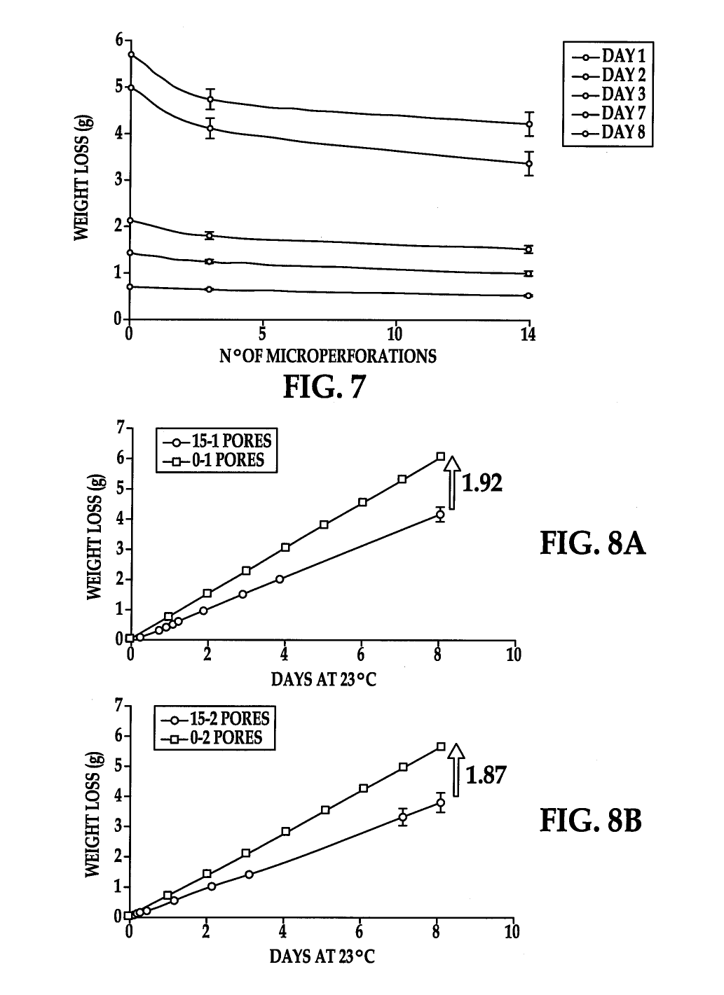

FIG. 7 illustrates the effect of the number of microperforations and storage days on the weight loss (%) of cultivated strawberries stored at 23° C/55% RH. As is shown in the figure, strawberries from all packages (with and without microperforations) exhibited a weight loss of less than 7% even after 8 days of storage at 55% RH and 23° C. (both storage conditions related to accelerated aging). The weight loss decreased with increasing number of microperforations. As can also be seen, this effect was more pronounced during the last days of storage. It seems that increases in the number of microperforations or in the storage time lead to a decrease in the strawberry weight loss. This behavior will help maintain an adequate moisture content for respiring products exposed to long storage periods. It is noted that values around or lower than 5% were reached with the microperforated packaging system. Thus, the presence of microperforations in the packaging system will keep strawberries in marketable conditions during 8 days at room temperature. Repeated experiments have consistently shown the effectiveness of this microperforated packaging system. As is illustrated in FIGS. 8a and 8b, for two different batches of cultivated strawberries packaged in PLA on different days and stored for 8 days at 55% RH, very similar differences in weight loss were observed between packaging systems with 0 and 15 microperforations (1.92% vs. 1.87%).

Results from FIGS. 7 and 8 shows that the weight loss of fruit packaged in the microperforated PLA containers had a behavior opposite to that expected for microperforated petroleum-based packaging systems. This is surprising and unexpected results when compared to such conventional petroleum-based packaging systems. In general, the weight loss of fresh product packaged in a microperforated packaging system increases with increasing number of microperforations. This has been reported by different authors who have worked with microperforated petroleum-based containers containing fresh product (Almenar, E.; Del Valle, V.; Hernandez-Munoz. P.; Lagaron, J. M.; Catalit, R.; Gavara, R. 2007. Equilibrium modified atmosphere packaging of wild strawberries. Journal of the Science of Food and Agriculture, 87: 1931-1939). The disclosure of which is herein incorporated by reference.

### Headspace Evolution

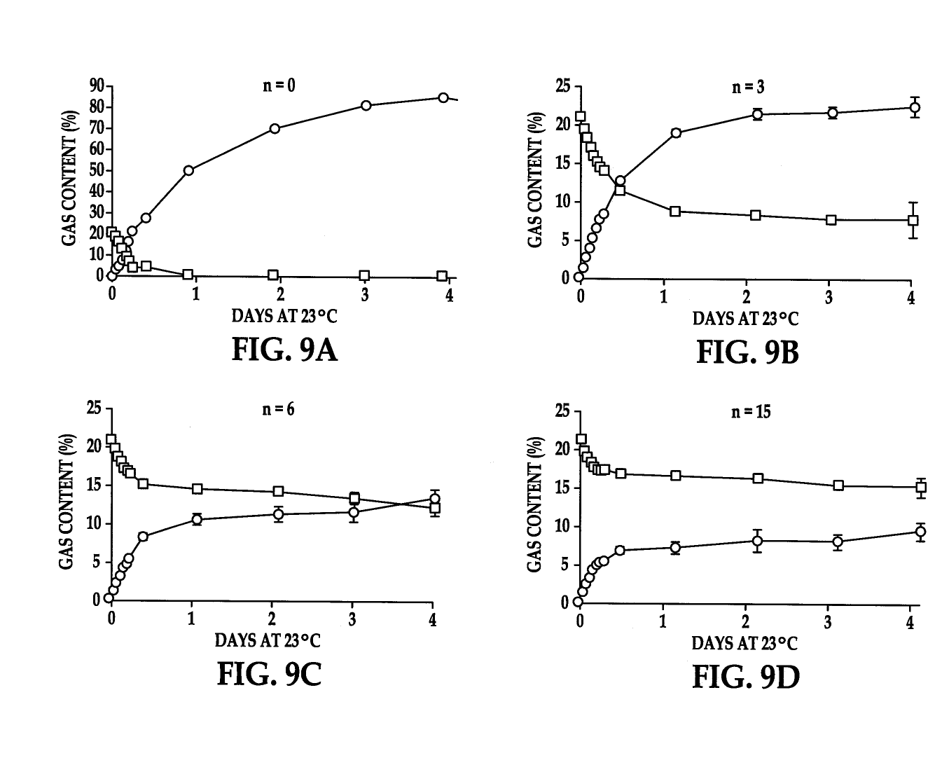

CO₂ and O₂ levels in the headspace of the PLA packaging systems were measured during storage using a headspace analyzer model 6600 (Illinois Instrument Inc., Johnsburg Ill., USA) For sampling, the needle attached to the instrument was inserted into the package headspace via a septum attached to the lid. The CO₂ and O₂ values are expressed in percentages. Results are illustrated in FIGS. 9a-d and 10a-b for storage at 23° C. and 3° C., respectively. Sampling was discontinued after 4 days due to the development of the fungus Botrytis cinerea. However, the tests are believed to provide sufficient support and are consistent with the findings expressed herein. Different CO₂ and O₂ levels were achieved depending on the number of microperforations (0, 3, 6 and 15) and temperature (3° C. and 23° C.). The larger the number of microperforations, the lower was the CO₂ and the higher the O₂ concentrations. Also, the higher the temperature, the higher the respiration rate and therefore the amount of CO₂.

These results are in agreement with those reported for cultivated strawberries packaged in microperforated petroleum-based packages (Sanz, C.; Perez. A. G.; Olias, R.; Olias, J. M.

2000. Modified atmosphere packaging of strawberry fruit: Effect of package perforation on oxygen and carbon dioxide. Food Science and Technology International, 6(1); 33-38). The disclosure of which is herein incorporated by reference.

In particular, FIG. 9 (n=0 perforations) shows that CO₂ and O₂ levels achieved after 24 hours in the PLA packaging systems without microperforations were detrimental for the fruit quality. It is well know that CO₂ levels higher than 20% and O₂ levels lower than 5% cause fermentation, changes in the aroma profile, acidity and other undesired attributes. Optimum storage conditions for cultivated strawberry are 20% CO₂ and 5% O₂ (Kader, A. A. 1992. Modified ;atmosphere during transport and storage. In: Kader A. A. (Ed.), Postharvest Technology and Horticultural Crops. Davis, Calif.: University of California, Division of Agriculture and Natural Resources. Publication, 3311. Pp. 85-92). The disclosures of which are herein incorporated by reference. Accordingly, an adequate atmosphere was achieved in the PLA packages with 3 microperforations (FIG. 9b, n=3). These gaseous concentrations were rapidly achieved during storage at room temperature. This atmosphere was not reached in the microperforated packages at low temperature due to the reduced respiration rate of the fruit at the lower temperature.

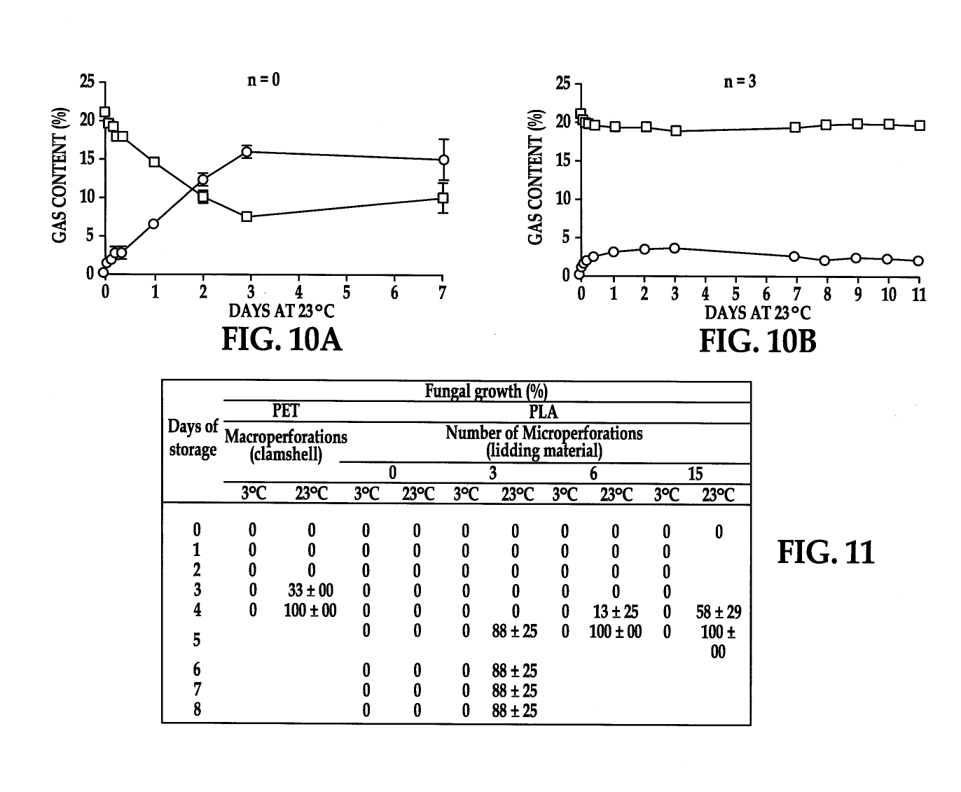

However, this does not cause any concern, since along with the respiration rate, the speed of all metabolic reactions is reduced at low temperature. Adequate gaseous levels were achieved in the absence of microperforations for storage at low temperature (FIG. 10a, n=0). Therefore, different numbers of microperforations are needed to achieve adequate CO₂/O₂ levels in the package depending on the storage temperature.

### Microbiology

Mold growth represented by Botrytis cinerea was assessed each day during storage. Botrytis cinerea development was visually estimated on each individual fruit utilizing the transparency of the packaging, material. Any strawberry, with visible mold growth was considered to be decayed. The results were expressed as percentage of fruit infected by fungus as shown in Table shown in FIG. 11.

No fungal growth was observed in any of the packages stored at low temperature. These results were in agreement with those reported by Sanz, Olias and Perez (2002) for microperforated petroleum-based packages (Sanz, C.; Olias, R.; Perez, A. G. 2002. Quality assessment of strawberries packed with perforated polypropylene punnets during cold storage. Food Science and Technology International, 8 (2): 65-71). The disclosure of which is herein incorporated by reference.

However, fungal growth was detected in all packages stored at room temperature except for those without microperforations. Botrytis cinerea growth was dependent on the number of microperforations due to the development of the different atmospheres as shown in FIG. 9a-d.

Thus, the fastest fungal growth was observed for strawberries packaged in the PLA packaging systems with 6 and 15 microperforations where after 4 days of storage fruits were contaminated. After 5 days of storage, strawberries packaged in the PLA packaging systems with 6 and 15 microperforations showed 100% contamination. Packages with 3 microperforations did not develop 100% fungal growth even after 8 days at 23° C. Strawberries from the PET clamshell containers showed fungal growth after 3 days of storage at room temperature. These results show the effectiveness of modified atmospheres on fungal growth reduction.

The effectiveness of this package to prolong respiring product shelf life and therefore, its validation as a packaging system for retail and wholesale, has been tested and shown to be successful.

In microperforated PLA-based packaging systems in which microperforated PLA film is used to form pouches, or is the lidding material used for PLA semi-rigid containers, the presence of microperforations reduces the water vapor transmission rate, and thus the weight loss of the fresh product. Such packages, when used for products with medium/high respiration rates particularly, will have reduced detrimental physico-chemical changes such as acidification, off-flavor development, and others during storage.

Therefore, microperforated PLA-based packaging systems which use microperforated PLA film as a lidding material for semi-rigid PLA trays or microperforated PLA for pouches will be more effective than microperforated petroleum-based packaging systems in prolonging fresh product shelf life. Weight loss will be reduced in addition to controlling the high/low concentrations of CO₂/O₂ (which could be far from the desired gaseous levels) that might be reached inside the package when continuous films are used to package the respiring produce.

The invention is based on a bio-based microperforated packaging system made of poly(lactic acid), PLA, for respiring products where CO₂ and O₂ fluxes are controlled (and therefore, respiration rates) and the water vapor transmission rates reduced to control weight loss. This invention provides the description of exemplary embodiments of the bio-based packaging system designed to prolong quality and shelf life of respiring products, particularly fresh fruit, fresh vegetables, fresh herbs and fresh flowers during the post harvest period. This will reduce problems associated with weight loss, softness, shrinkage and others in fresh produce caused by the use of continuous films and the environmental issues caused by the use of petroleum-based polymeric materials.

Conservation of fresh product can by achieved by modifying atmospheric conditions such as gas composition and relative humidity. It can also be obtained by selecting an adequate packaging system. Microperforated materials are a powerful tool that can prolong respiring product shelf life. Ripening/shriveling, the respiration rate, fungal growth and other changes can be controlled since different gas compositions can be reached depending on the size and area of the perforations and their number. For products with medium or high respiration rate microperforated materials could be used in order to mitigate the high/low concentrations of CO₂/O₂, respectively, which might occur in a continuous film packaging system. The water vapor transmission rate of the material is also increased compared with the values of a continuous film. Thus, higher weight loss is expected during post harvest period for respiring products packaged in the currently available microperforated systems.

Poly(lactic acid), PLA, is a bio-based polymeric material that is biodegradable and compostable, and thus it is an environmentally friendly alternative to petroleum-based packaging, materials. Bio-based films made from PLA have been microperforated and then used as a lidding material for PLA packaging systems and/or for forming pouches. These packages (microperforated PLA used as lidding material for PLA trays) have been tested with fresh product (cultivated strawberry fruit) to determine their effect on shelf life. As expected, the CO₂/O₂ levels increased/decreased, respectively, but less rapidly than was observed for continuous material.

However, water vapor transmission showed a different behavior than what one would expect. The higher the number of microperforations and the greater the void area, the lower was the weight loss of the product. These results were confirmed with mass transfer studies for water vapor. Therefore, the use of bio-based microperforated packaging systems based on PLA helps to prolong, respiring product shelf life and thus its marketability. In addition, the use of these bio-based microperforated materials could be an environmentally friendly alternative to the microperforated petroleum-based material currently in use.

Embodiments of the invention may also be used in different post harvest conservation techniques used for fresh product during retail and wholesale. These technologies include: equilibrium modified atmosphere packaging (EMAP), modified atmosphere packaging (MAP) and active packaging (AP).

The fresh retail market in addition to bulk distribution systems could make use of this microperforated biobased system. The unique combination of selective modification to control the CO₂/O₂ ratio.

Obviously, many modifications and variations of the present invention are possible in light of the above teachings. Although exemplary aspects and embodiments of the invention and forming methods have been described with a full set of features, it is to be understood that the disclosed systems and methods of use and manufacture may be practiced successfully without the incorporation of each of those features. The foregoing described embodiments of the invention are provided as illustrations and descriptions. They are not intended to limit the invention to the precise forms described herein. In particular, it is contemplated that functional implementation of the invention described herein may be constructed of different packaging arrangements. For example, it should be readily apparent that a system of the invention may be formed in a variety of sizes and shapes. Suitable shapes for the include, but are not limited to, a polygon such as, a cube, an elongated rectangle, a polygon with one or more rounded corners, a shape that mimics the product contained within (e.g., a spherical shape for melons). Thus, variations and embodiments are possible in light of above teachings, and it is not intended that this description should limit the scope of invention. It is to be understood that modifications and variations may be utilized without departure from the spirit and scope of the invention and method disclosed herein, as those skilled in the art will readily understand. Such modifications and variations are considered to be within the purview and scope of the appended claims and their equivalents.

What is claimed is:

1. A packaging system comprising a sidewall, bottom and lid formed substantially of a biobased polymeric material and configured to enclose a storage space defined therein, wherein at least a portion of the sidewall, bottom or lid is microperforated.

2. A packaging system as recited in claim 1, wherein the polymeric material is poly(lactic acid).

3. A packaging system as recited in claim 1, wherein the packaging system is in the form of a sealable pouch.

4. A packaging system, as recited in claim 1, further comprising a separable tray and a lid composed of the polymeric material.

5. A packaging system as recited in claim 1, wherein the number of microperforations is selected based on the product to be enclosed in the storage space.

6. A packaging system as recited in claim 1, wherein the pore size of the microperforations varies.

7. A packaging system as recited in claim 1, wherein the pore size of the microperforations is substantially the same.

8. A method of forming a packaging system, comprising the steps of:
a. transferring a film of biobased polymeric material between a first roller and a second roller;
b. microperforating the film material; and
c. sealing the film material over a tray, wherein the tray includes a bottom, and sidewall defining a storage space therein.

9. A method as recited in claim 8, wherein the microperforations are uniformly distributed along the film material.

10. A method as recited in claim 8, wherein the microperforations are elliptical in shape.

11. A package comprising:
a bottom portion including a sidewall and a bottom surface, defining a storage space therein; and
a top portion configured for being engaged with the bottom portion to substantially enclose the storage space,
wherein the top portion is at least partially composed of a microperforated PLA material.

12. The package recited in claim 11, wherein the top portion is a film material sealed over the bottom portion.

13. The package recited in claim 11, wherein the top portion is substantially composed of microperforated PLA.

14. The package recited in claim 11, wherein the bottom portion has a substantially square profile.

15. The package as recited in claim 11, wherein the top portion is a lid separable from the bottom portion.

16. The package as recited in claim 11, wherein the microperforations in the PLA material are uniformly distributed.

17. The package as recited in claim 11, wherein the microperforations in the PLA material are present in an amount between 1 and 20.

18. The package as recited in claim 11, wherein the bottom portion is composed substantially of PLA.

19. The package as recited in claim 11, wherein the bottom portion is at least partially composed of microperforated PLA.

20. The package as recited in claim 11, wherein the microperforation is substantially elliptical shaped.
